(19) United States
(12) Patent Application Publication
(10) Pub. No.: US 2007/0152072 A1
(43) Pub. Date: Jul. 5, 2007

(54) IC CARD WITH IMPROVED PLATED MODULE

(75) Inventors: Paolo Frallicciardi, Salerno (IT); Edoardo Visconti, Marigliano (Napoli) (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Incard S.A., Geneva (CH)

(21) Appl. No.: 11/618,413

(22) Filed: Dec. 29, 2006

(30) Foreign Application Priority Data
Dec. 30, 2005 (EP) 05028724.2

(51) Int. Cl. G06K 19/06

(52) U.S. Cl. 235/492

(57) ABSTRACT

An IC card includes a plated or protective module including a printed circuit having a plurality of conductive areas, delimited by a network of insulating channels, for covering an integrated circuit chip, a plastic support with a recess intended to host the plated module and the integrated circuit chip, with at least some of the conductive areas connected to corresponding contact points on the integrated circuit chip. A plurality of extended areas are linked to a corresponding conductive areas by one or more bridges. A couple of advanced extended areas form a rounded border of the plated module. Advanced extended areas are linked to conductive areas not connected to contact points. Advanced extended areas wrap around the extended areas and form the opposite rounded sides of the plated module.

### FIELD OF THE INVENTION

The present invention relates to an IC card comprising a plastic support with a recess, an integrated circuit chip hosted in the recess, a plated module including a printed circuit comprising a plurality of conductive areas, delimited by a network of insulating channels, for covering the integrated circuit chip, with at least some of the conductive areas being connected to a corresponding contact point of the integrated circuit chip.

### BACKGROUND OF THE INVENTION

As is well known an IC card generally comprises a plastic support with a recess, an integrated circuit chip and a printed circuit, with the printed circuit wire bonded on the integrated circuit chip and glued inside the recess with an epoxy resin. With reference to FIG. 1, an IC card 10 is represented in an exploded view, with the plastic support indicated with numeral reference 1, the recess with 6, the printed circuit and the integrated circuit chip respectively indicated with numeral references 2 and 3.

More particularly, the printed circuit 2 comprises a plurality of conductive areas a1, . . . , an, glued through stripes of epoxy resin 9. The integrated circuit chip 3 is fixed and electrically connected through wires bonded beneath the printed circuit 2, and then sealed in the recess 6. The electrical connections are clearly shown in FIGS. 2a and 2b, representing respectively a top view of the printed circuit 2, sealed inside the recess 6 with the integrated circuit chip 3 beneath, and the corresponding lateral cross section.

Some or all of the conductive areas a1, . . . , ak (if all, n=k) are connected through a corresponding plurality of bonding wires w1, . . . wj to the integrated circuit chip 3 at a plurality of contact points c1, . . . , ck. These contact points c1, . . . , ck provide communication connection between an external read write device 4 and the integrated circuit chip 3.

More particularly, the communication between a wireless external read and write device 8 and the IC card 10 is contactless when the IC card 10 is provided with an antenna 5, laying inside the plastic support 1 and connected to the contact points c1 . . . ck through a couple of pads p1, p2 as schematically shown in FIG. 3. The antenna 5 sends and receives electromagnetic waves to and from a coupling antenna 7, included in the wireless external read write device 8, with the integrated circuit chip 3 powered by electromagnetic induction from the wireless external read write device 8. Generally, when the IC card 10 is able to communicate both in contact and in contactless mode it may be defined as a combined or comby IC card 10.

The IC card 10 takes its intelligence from the integrated circuit chip 3 that is integrated by silicon technology and is easy to break. As is well known, those cards are widely used for many purposes, for instance: providing credit cards, telephone cards, smart cards, pre-paid access cards; ID cards; badge passes; etc.

According to the different application fields, those cards may be kept by a user in a wallet or envelope that might be protective but still subjects bending or stress forces onto the IC card itself. Therefore, in order to avoid breakage when the IC card 10 is bent, the integrated circuit chip 3 is restricted to only a few millimeters in size and is protected through the printed circuit 2 from physical pressures and static electricity.

More particularly, to hold the integrated circuit chip 3 assembled with the printed circuit 2, the recess 6 is milled into the plastic support 1 using a CNC machine with multiple drill bits, the dimension and location of the recess 6 being carefully controlled to meet with ISO standards. Nevertheless, since the IC card is usually kept by hand and hidden in a wallet, it undergoes damage and stress mainly with respect to the printed circuit 2 and the integrated circuit chip 3, especially around the recess 6 wherein the IC circuit lies.

More particularly, when the IC card 10 is deformed or stressed, all the forces act in proximity to the external circumference of the recess 6, sometimes causing the partial detaching of the integrated circuit chip 3 from the plastic support 1 or a bending of the module producing a detaching between a conductive area and a contact point. Even if these forces do not cause the detaching, the contact points c1 . . . ck may be damaged, causing the communication between the integrated circuit chip 3 and the external read write device 4 to fail. Also the communication with the wireless external read write device 8 may be damaged, due to forces on the antenna 5, especially on pads p1 and p2 that are located near the external circumference of the printed circuit 2.

U.S. Pat. No. 5,834,755 discloses an IC card including a bypass stress for a mechanical isolation of the integrated circuit chip. Even if the bypass stress is intended to protect the integrated circuit chip from forces, it does not disclose how to protect such an integrated circuit chip when it is connected to an antenna, for example when the IC card is a combined IC card. Also United States patent application No. 2003/016507 and the German patent application No. DE 101 01 280 are limited to a mechanical isolation of the integrated circuit chip of the type described above. German patent application No. DE 198 26 428 provides a mechanical discontinuity for reacting against forces. Such mechanical discontinuity is provided outside the area wherein the integrated circuit chip and the antenna are positioned, resulting in a substantial modification of the plated or protective module that supports the antenna and the integrated circuit chip.

### SUMMARY OF THE INVENTION

The aim of the present invention is to provide an IC card resistant to forces due to bending or deforming the plastic support of the IC card, especially reducing the effect of these forces in proximity to the recess of the plastic support in which the printed circuit and the integrated circuit chip are inserted and fixed.

Another aim of the present invention is to provide an IC card resistant to possible breakage of portions of conductive areas or their partial detachment from the recess, in order to preserve the use of the IC card also when such breaks or partial detachment occur.

A further aim of the present invention is to safeguard the contact points between the conductive areas and the integrated circuit and to reinforce the connection between the pads and the antenna.

One embodiment is directed to an IC card comprising a plastic support with a recess, an integrated circuit chip hosted in the recess, a plated or protective module including a printed circuit comprising a plurality of conductive areas, delimited by a network of insulating channels, for covering the integrated circuit chip, with at least some of the conductive areas being connected to a corresponding contact point of the integrated circuit chip. A plurality of extended areas are linked to corresponding conductive areas by one or more bridges.

The present invention the surface of the conductive areas of the IC card plated module is enlarged in order to provide extended areas linked to at least some conductive areas by a bridge.

In another embodiment the IC card comprises a plastic support with a recess, an antenna laying inside the plastic support, an integrated circuit chip hosted in the recess, and a plated module including a printed circuit. The printed circuit comprises a plurality of conductive areas, delimited by a network of insulating channels, for covering an integrated circuit chip, with the integrated circuit chip connected with a plurality of contact points to at least some of the conductive areas and the contact points connected to the antenna through a couple of pads, wherein a plurality of extended areas are linked to a corresponding conductive areas by one or more bridges.

### BRIEF DESCRIPTION OF THE DRAWINGS

Further features and advantages of the invention will be apparent from the following description of an embodiment thereof, given by way of non-limitative example with reference to the accompanying drawings.

FIG. 1 schematically represents, in a perspective exploded view, an IC card comprising a plated module according to the prior art.

FIG. 2a schematically represents, in a top view, the plated module of FIG. 1 according to the prior art.

FIG. 2b schematically represents a lateral view of FIG. 2a according to the prior art.

FIG. 3 schematically represents the connection between a plated module and an antenna, according to the prior art.

FIG. 4 schematically represents, in a top view, an IC card provided with a plated module according to the present invention.

FIG. 5 schematically represents, in major details the plated module of FIG. 4.

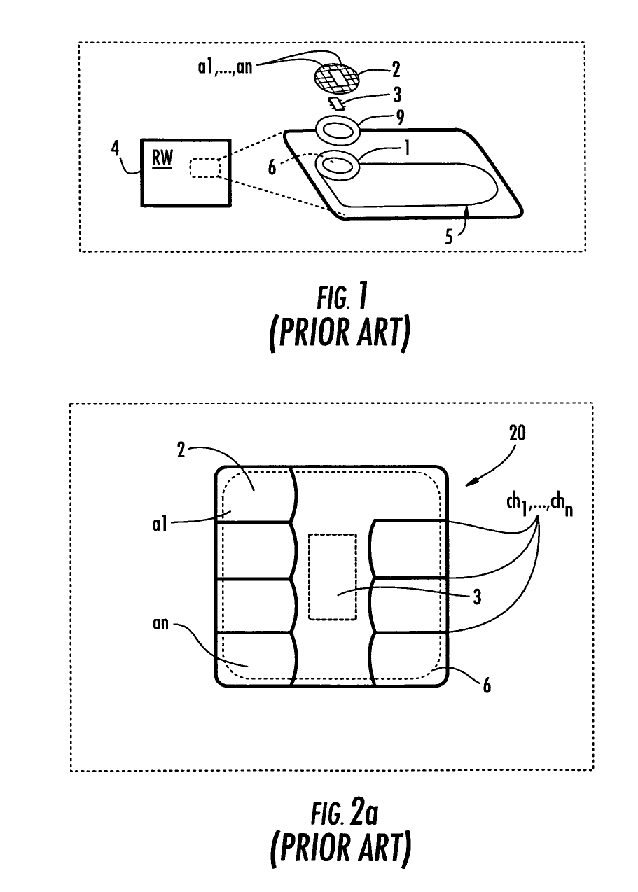

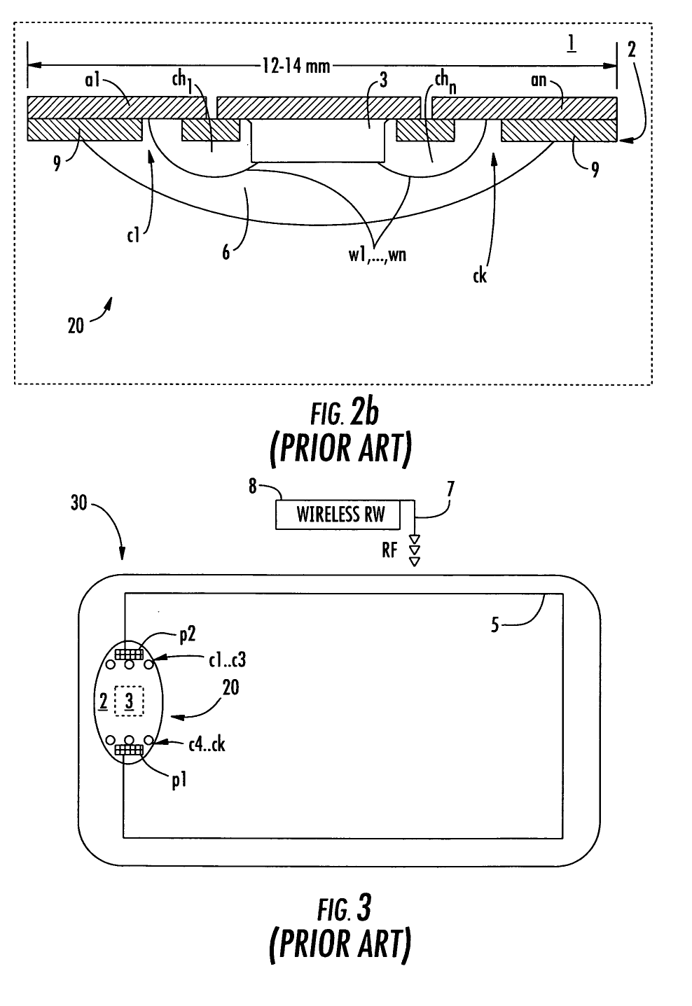

### DETAILED DESCRIPTION OF THE PREFERRED EMBODIMENTS

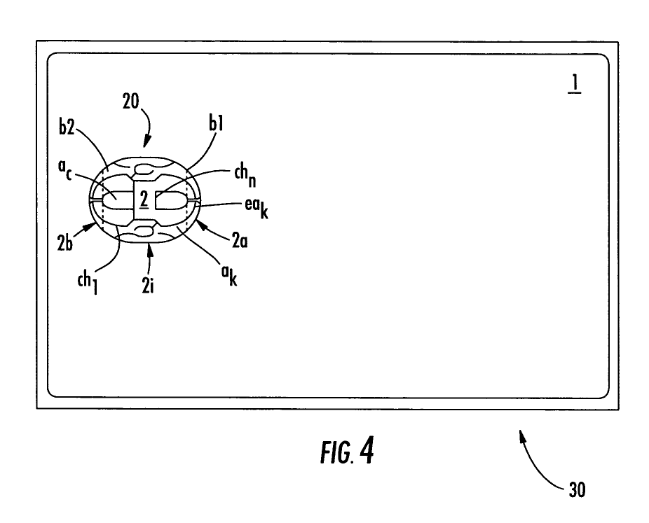

With reference to FIG. 4 is shown and is globally indicated with 30 an IC card comprising a plastic support 1 and a plated module 20, glued inside a recess 6 not explicitly shown because conventional. The plated or protective module 20 includes a printed circuit 2, comprising a plurality of conductive areas a₁, . . . , aₙ, delimited by a network of insulating channels ch₁, . . . , chₙ, covering an integrated circuit chip 3.

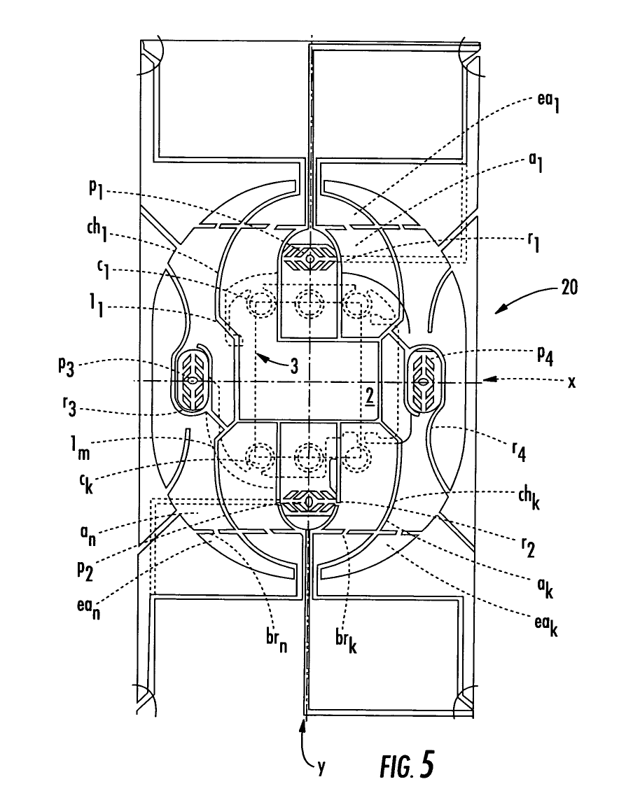

More particularly, as shown in FIG. 5, at least some of the conductive areas a₁, . . . , aₙ are connected through wire bonding w₁, . . . , wₖ to a corresponding contact point c₁, . . . , cₖ on the integrated circuit chip 3, so as to provided communication connection between an external read write device 4 and the integrated circuit chip 3. Accordingly, a plurality extended areas ea₁, . . . , eaₘ at the border of the recess 6 are linked to at least some of the conductive areas a₁, . . . , aₙ through one or more bridge br₁, . . . , brₙ.

An extended area ea₁, . . . , eaₘ is delimited from a nearby extended area ea₁, . . . . eaₘ or from a corresponding conductive area a₁, . . . , aₙ by an additional insulating channel chₖ₊₁. More particularly, the extended areas ea₁, . . . , eaₖ are formed by the same material used for the corresponding conductive areas a₁, . . . , aₙ. Also the bridge br₁, . . . , brₙ may be formed by the same material used for the conductive areas a₁, . . . , aₙ. The insulating channels ch₁, . . . , chₖ surround the conductive areas a₁, . . . , aₙ as a frame, so as to protect the connection between the corresponding contact point c₁, . . . , cₖ.

More particularly, an insulating channel b₁, divides the conductive areas a₁, . . . , aₙ from the nearby extended areas ea₁, . . . , eaₘ with the insulating channel b1 crossed by a plurality of bridges br₁, . . . , brₙ. The insulating channel b1 and the bridges br₁, . . . , brₙ act as a mechanical bypass between an internal part 2i, including the conductive areas a₁, . . . , aₙ, and a border part 2a, 2b, including the extended areas ea₁, . . . , eaₘ. The mechanical bypass is intended to absorb forces on the internal part 2i.

Advantageously, the plated module 20 has a rounded border formed by, at least, a couple of advanced extended areas ea₁,eaₙ. The advanced extended areas ea₁, . . . , eaₙ forming the round border of the plated module 20 are linked to corresponding conductive area a₁, . . . , aₙ, advantageously not associated with the integrated circuit chip with corresponding contact points c₁, . . . , cₖ.

The advanced extended areas ea₁, . . . , eaₙ forming the round border, circle or wrap around other extended areas ea₁, . . . , eaₙ, especially those extended areas associated with conductive areas a₁, . . . , aₙ linked with contact points c₁, . . . , cₖ. In this way, the forces acting on the border of the recess 6 are distributed especially on extended area ea₁, . . . , eaₙ that are passive respect the functioning of the integrated circuit 3.

The advanced extended areas ea₁, . . . , eaₙ and the extended areas ea₁, . . . , eaₙ are separated by the conductive areas a₁, . . . , aₙ through an alignment of insulating channels that look like a weakening line represented by the insulating channel b1 or b2 crossed by the plurality of bridges br₁, . . . , brₙ. More particularly, both the border of the plated module 20 may be rounded by corresponding ones of the advanced extended areas ea₁, . . . , eaₘ.

The conductive area a₁, . . . , aₙ has at least a major side curved. Also a minor side of the conductive area a₁, . . . , aₙ may be curved, to round and protect the connection with the corresponding contact point c₁, . . . , cₖ being wire bonded. More particularly, at least one central conductive area a_{c} has a semi-circumferential side.

In case of contactless communication an external read-write device 8 is connected to the integrated circuit chip 3, the antenna 5 laying inside the plastic support 1 being connected to the contact points c₁, . . . , cⱼ through a couple of pads p₁, p₂ in a standard way. Advantageously, the pads p₁, p₂ are inside the internal part 2i of the plated module 20, with the forces acting on the border of the recess 6, and generally on the plated module 1, absorbed by the extended area ea₁, . . . , eaₙ, in favor of the pads p1, p2.

More particularly, a plurality of redundancy pads p₃, p₄, advantageously inside the internal part 2i, are used to connect the antenna 5 and the contact points c₁, . . . , cⱼ. In this way, a supplying of power from the antenna 5 to the contact points c₁, . . . , cⱼ is guaranteed also when some or both of the pads p₁, p₂ are broken. More particularly, a plurality of insulating channels r1, r2, r3, r4 protect the pads p1, p2, p3, p4.

The recess 6 is milled in a location of the plastic support 1 less exposed to forces. For instance, considering an x axis as a major axis of a major surface of the IC card and an y axis as a minor axis of the same surface, the recess 6 is de-centered or offset with respect to the x and/or the y axis. For example the recess 6 may be included inside a quadrant q of the plastic support 1, with the quadrant q delimited by the major and minor axes x, y.

According to another embodiment, the extended areas ea₁, . . . , eaₙ are not formed of the same material used for the corresponding conductive area a₁, . . . , aₙ. For instance, the extended areas ea₁, . . . , eaₙ are formed by epoxy resin 9 filling the external parts 2a, 2b and absorbing forces acting on the border of the plated module 30. Moreover, the epoxy resin 9, distributed on the external parts 2a, 2b, increases the adherence of the conductive areas a₁, aₙ on the internal part 2i.

According to another embodiment, the extended areas ea₁, . . . , eaₙ are formed by a material different from epoxy resin, for example, an insulating or conductive material with easy coupling with the recess 6 and resistant to forces and pressures.

Advantageously, the IC card is resistant to forces due to deforming, especially reducing the effect of these forces in proximity to the recess 6 of the plastic support 1 wherein the printed circuit 2 and the integrated circuit chip 3 reside.

The plurality of extended areas of the plated module 20 in fact, absorb forces near the border of recess 6 and protects the contact points c1 . . . ck that connects the conductive areas a1, . . . , an of the printed circuit 1 to the respective bonding wires w1, . . . , wn.

A possible break of an extended area ea₁, . . . , eaₙ, its detachment from the recess 6 or a dissociation with a corresponding conductive area does not cause the failure of the IC card while in case of contactless communication the break of the pads p1, p2 are addressed by the redundancy pads p3, p4.

The concentric disposition of the advanced extended areas ea₁, . . . , eaₙ as a protection of the extended areas ea₁, . . . , eaₙ linked to conductive areas directly associated to the integrated circuit chip 3 or to the corresponding pads p1, p2, p3, p4 may preserve the functioning of the integrated circuit chip 3. Other aspects of the IC card and module are disclosed in copending patent application entitled: PLATED MODULE FOR AN IC CARD, attorney docket no. 53807, filed concurrently herewith.

1-34. (canceled)

35. An integrated circuit (IC) card comprising:
a support with a recess therein;
an IC chip in the recess and having a plurality of contact points; and
a printed circuit covering said IC chip and comprising
a network of insulating channels,
a plurality of conductive areas delimited by said network of insulating channels, at least one of the conductive areas being connected to a corresponding contact point of said IC chip,
at least one extended area, and
at least one bridge linking the at least one extended area to a corresponding conductive area.

36. The IC card according to claim 35 wherein said at least one extended area is conductive.

37. The IC card according to claim 35 wherein said at least one bridge is conductive.

38. The IC card according to claim 35 wherein said at least one extended area is separated from the corresponding conductive area by an insulating channel crossed by said at least one bridge.

39. The IC card according to claim 35 wherein said network of insulating channels surround said plurality of conductive areas as a protection frame for said plurality of contact points.

40. The IC card according to claim 39 wherein at least one major side of at least one of said plurality of conductive areas is curved.

41. The IC card according to claim 35 wherein said at least one extended area comprises a plurality of advanced extended areas; and wherein first advanced extended areas form a first rounded border.

42. The IC card according to claim 41 wherein second advanced extended areas form a second rounded border opposite the first rounded border.

43. The IC card according to claim 41 wherein said plurality of extended areas further comprises third extended areas; and wherein said first and second advanced extended areas wrap around said third extended areas.

44. The IC card according to claim 41 wherein said first and second advanced extended areas are linked to conductive areas not associated with contact points.

45. The IC card according to claim 35 wherein said plurality of conductive areas comprises at least one central conductive area having a semi-circular side.

46. The IC card according to claim 35 wherein said at least one extended area comprises insulating material.

47. The IC card according to claim 35 wherein said at least one bridge comprises insulating material.

48. The IC card according to claim 35 wherein said support has a major axis and a minor axis; and wherein the recess is offset with respect to at least one of the major axis and minor axis of said support.

49. The IC card according to claim 35 further comprising an antenna carried by said support and coupled to said IC chip.

50. The IC Card according to claim 49 further comprising a plurality of redundancy pads coupling said antenna and corresponding contact points.

51. The IC Card according to claim 50 wherein a plurality of insulating channels wrap around said plurality of redundancy pads.

52. The IC card according to claim 35 wherein said support comprises plastic.

53. An integrated circuit (IC) card comprising:
a plastic support with a recess therein;
an IC chip in the recess and having a plurality of contact points;
an antenna carried by said plastic support and coupled to said IC chip; and
a printed circuit covering said IC chip and comprising
a network of insulating channels,
a plurality of conductive areas delimited by said network of insulating channels and at least some of the conductive areas being connected to corresponding contact points of said IC chip,
a plurality of extended areas, and
at least one bridge linking each extended area to a corresponding conductive area.

54. The IC card according to claim 53 wherein said plurality of extended areas are conductive; and wherein said plurality of bridges are conductive.

55. The IC card according to claim 53 wherein said plurality of extended areas comprises a plurality of advanced extended areas; wherein first advanced extended areas form a first rounded border; and wherein second advanced extended areas form a second rounded border opposite the first rounded border.

56. The IC card according to claim 55 wherein said plurality of extended areas further comprises third extended areas; and wherein said first and second advanced extended areas wrap around said third extended areas.

57. The IC card according to claim 55 wherein said first and second advanced extended areas are linked to conductive areas not associated with contact points.

58. The IC card according to claim 53 wherein said plurality of extended areas comprise insulating material; and wherein said plurality of bridges comprise insulating material.

59. The IC card according to claim 53 wherein said support has a major axis and a minor axis; and wherein the recess is offset with respect to at least one of the major axis and minor axis of said support.

60. The IC Card according to claim 53 further comprising a plurality of redundancy pads coupling said antenna and corresponding contact points.

61. The IC Card according to claim 60 wherein a plurality of insulating channels wrap around said plurality of redundancy pads.

62. A method for making an integrated circuit (IC) card comprising:
providing a support with a recess therein;
positioning an IC chip in the recess and having a plurality of contact points; and
positioning a printed circuit to cover the IC chip and comprising
a network of insulating channels,
a plurality of conductive areas delimited by the network of insulating channels, at least one of the conductive areas being connected to a corresponding contact point of the IC chip,
at least one extended area, and
at least one bridge linking the at least one extended area to a corresponding conductive area.

63. The method according to claim 62 wherein the at least one extended area is conductive; and wherein the at least one bridge is conductive.

64. The method according to claim 62 wherein the at least one extended area is separated from the corresponding conductive area by an insulating channel crossed by the at least one bridge.

65. The method according to claim 62 wherein the at least one extended area comprises a plurality of advanced extended areas; wherein first advanced extended areas form a first rounded border; and wherein second advanced extended areas form a second rounded border opposite the first rounded border.

66. The method according to claim 65 wherein the plurality of extended areas further comprises third extended areas; and wherein the first and second advanced extended areas wrap around the third extended areas.

67. The method according to claim 62 wherein the first and second advanced extended areas are linked to conductive areas not associated with contact points.

68. The method according to claim 62 wherein the plurality of conductive areas comprises at least one central conductive area having a semi-circular side.

69. The method according to claim 62 wherein the at least one extended area comprises insulating material;
and wherein the at least one bridge comprises insulating material.

70. The method according to claim 62 wherein the support has a major axis and a minor axis; and wherein the recess is offset with respect to at least one of the major axis and minor axis of the support.

71. The method according to claim 62 further comprising an antenna carried by the support and coupled to the IC chip.
